(19) United States
(12) Patent Application Publication
(10) Pub. No.: US 2022/0393495 A1
(43) Pub. Date: Dec. 8, 2022

(54) WEARABLE EARPHONE CHARGER

(71) Applicant: Shenzhen Huinn Innovation Technology Co., Ltd., Shenzhen (CN)

(72) Inventor: TIANYOU LIAO, Shenzhen (CN)

(21) Appl. No.: 17/889,328

(22) Filed: Aug. 16, 2022

Related U.S. Application Data
(63) Continuation of application No. PCT/CN2021/075964, filed on Feb. 8, 2021.

(30) Foreign Application Priority Data
Feb. 19, 2020 (CN) 2020201847302

(51) Int. Cl. H02J 7/00; H04R 1/10

(52) U.S. Cl. CPC H02J 7/00304; H02J 7/0042; H02J 7/0047; H02J 7/0034; H04R 1/1025

(57) ABSTRACT

A wearable earphone charger with automatic adjustment of positive and negative polarities includes a wearable bracket and two power supply seats disposed on the bracket. The bracket is provided with a power supply integrated control board and a power supply electrically connected to each other. Each of the two power supply seats is electrically connected to the power supply integrated control board, is provided with first and second power supply contacts that are used to supply power to an earphone, and is further provided with a detection contact. The power supply integrated control board is provided with a detection circuit used to detect whether the earphone is connected, and the detection circuit is electrically connected to the detection contact. The wearable earphone charger can realize automatic adjustment of positive and negative polarities of the wearable earphone charger, and thus is with high reliability and improved user experience.

### CROSS-REFERENCE TO RELATED APPLICATION

The disclosure is a continuation of International Application No. PCT/CN2021/075964, filed on Feb. 8, 2021. The International Application claims priority from Chinese utility model patent with a patent application No. 202020184730.2, filed on Feb. 19, 2020, and entitled “wearable earphone charger with automatic adjustment of positive and negative polarities”. The entire contents of the above-mentioned applications are hereby incorporated herein by reference.

### TECHNICAL FIELD

The disclosure relates to the field of BLUETOOTH earphone charging technologies, and in particularly to, a wearable earphone charger with automatic adjustment of positive and negative polarities.

### BACKGROUND

Output polarities of an existing battery charging device do not change with requirements of charged devices, and the polarities are usually fixed by structural constraints on positive and negative polarities, for example, various plugs of mobile phones and a structure of a BLUETOOTH headphone charging box being not allowed to be reversely inserted, and central symmetry of the type-C interface each form a limitation of positive and negative polarities. However, the structural constraints would increase structural design workloads and process requirements, and even some facilities are difficult to achieve the structural constraints. Therefore, it is an urgent problem for those skilled in the related art to provide a wearable earphone charger with automatic adjustment of positive and negative polarities.

### SUMMARY

A technical problem to be solved in the disclosure is to provide a wearable earphone charger with automatic adjustment of positive and negative polarities in view of the above defects of the related art.

Specifically, an embodiment of the disclosure provide a wearable earphone charger, including: a wearable bracket and two power supply seats disposed on the bracket; the bracket is disposed with a power supply integrated control board and a power supply, and the power supply integrated control board and the power supply are electrically connected with each other; the two power supply seats are electrically connected to the power supply integrated control board individually, and each of the two power supply seats is disposed with a first power supply contact and a second power supply contact that are configured to supply power to an earphone, and is further disposed with a detection contact; and the power supply integrated control board is disposed with a detection circuit configured to detect whether the earphone is connected thereto, and the detection circuit is electrically connected to the detection contact.

In an embodiment of the disclosure, the power supply integrated control board is further disposed with a main control circuit, an overcurrent and short-circuit protection circuit, and a polarity reversal control circuit; the main control circuit includes a single-chip microcomputer controller, and the overcurrent and short-circuit protection circuit and the polarity reversal control circuit are electrically connected to the single-chip microcomputer controller.

In an embodiment of the disclosure, the detection circuit includes: a first resistor and a second resistor; a first end of the single-chip microcomputer controller is electrically connected to the detection contact through the first resistor, and configured to detect a voltage on the detection contact; and a second end of the single-chip microcomputer controller is electrically connected to the detection contact through the second resistor, and configured to supply one of a pull-up voltage and a pull-down voltage to the detection circuit.

In an embodiment of the disclosure, the polarity reversal control circuit includes a polarity reversal controller, a third resistor, a fourth resistor, and a fifth resistor; a first end of the third resistor is electrically connected to a third end of the single-chip microcomputer controller, a second end of the third resistor is electrically connected to the overcurrent and short-circuit protection circuit and a first end of the polarity reversal controller, and the third end of the single-chip microcomputer controller is configured to detect a state parameter of indicating whether there is a short-circuit behavior or indicating a magnitude of a current; a second end of the polarity reversal controller is electrically connected to the first power supply contact and a first end of the fourth resistor, a second end of the fourth resistor is grounded, a third end of the polarity reversal controller is electrically connected to a first end of the fifth resistor and the second power supply contact, and a second end of the fifth resistor is grounded; and a fourth end and a fifth end of the polarity reversal controller are electrically connected to a fourth end and a fifth end of the single-chip microcomputer controller respectively, a sixth end of the polarity reversal controller is grounded, and the fourth end and the fifth end of the single-chip microcomputer controller are configured to output polarity control signals respectively.

In an embodiment of the disclosure, the overcurrent and short-circuit protection circuit includes: an overcurrent and short-circuit protection controller, a first end of the overcurrent and short-circuit protection controller is electrically connected to the second end of the third resistor, and a second end of the overcurrent and short-circuit protection controller is electrically connected to the power supply, and a third end of the overcurrent and short-circuit protection controller is grounded.

In an embodiment of the disclosure, the main control circuit further includes: a first capacitor, a first end of the first capacitor is electrically connected to a sixth end of the single-chip microcomputer controller and a high potential terminal, and a second end of the first capacitor is grounded.

In an embodiment of the disclosure, a supply voltage of the power supply is +5V.

In an embodiment of the disclosure, before charging the earphone, the detection circuit is further configured to detect a polarity of an electrode of the earphone in contact with the first power supply contact and the second power supply contact is positive or negative.

In another aspect, an embodiment of the disclosure provides a wearable earphone charger, including: a wearable bracket and two power supply seats disposed on the bracket; wherein the bracket is provided with a power supply integrated control board and a power supply that are electrically connected with each other; and each of the two power supply seats is provided with a first power supply contact and a second power supply contact that are configured to supply power to an earphone, and is further provided with a detection contact; and the power supply integrated control board is provided with a main control circuit, a polarity reversal control circuit and a detection circuit configured to detect whether the earphone is connected thereto; the detection circuit is electrically connected to the main control circuit and the detection contact, and the polarity reversal control circuit is electrically connected to the main control circuit, the power supply, the first power supply contact and the second power supply contact.

In an embodiment of the disclosure, the main control circuit includes a microcontroller, and the microcontroller has first to fifth ends; the detection circuit includes a first resistor and a second resistor; the first end of the microcontroller is electrically connected to the detection contact through the first resistor, and configured to detect a voltage on the detection contact; and the second end of the microcontroller is electrically connected to the detection contact through the second resistor, and configured to supply one of a pull-up voltage and a pull-down voltage to the detection circuit; and the polarity reversal control circuit includes: a polarity reversal controller, a third resistor, a fourth resistor, and a fifth resistor; a first end of the third resistor is electrically connected to the third end of the microcontroller, a second end of the third resistor is electrically connected to a first end of the polarity reversal controller, the first end of the polarity reversal controller is electrically connected to the power supply through an overcurrent and short-circuit protection circuit, the third end of the microcontroller is configured to detect a state parameter of indicating whether there is short-circuit behavior or indicating a magnitude of a current, a second end of the polarity reversal controller is electrically connected to the first power supply contact and a first end of the fourth resistor, a second end of the fourth resistor is grounded, a third end of the polarity reversal controller is electrically connected to a first end of the fifth resistor and the second power supply contact, and a second end of the fifth resistor is grounded; a fourth end and a fifth end of the polarity reversal controller are electrically connected to the fourth end and the fifth end of the microcontroller respectively, a sixth end of the polarity reversal controller is grounded, and the fourth end and the fifth end of the microcontroller are configured to output polarity control signals respectively.

In a still another embodiment, an embodiment of the disclosure provides a wearable earphone charger, including: a wearable bracket and two power supply seats disposed on the bracket; wherein the bracket is provided with a power supply integrated control board and a power supply, and the power supply integrated control board and the power supply are electrically connected with each other; and each of the two power supply seats is provided with a first power supply contact and a second power supply contact that are configured to supply power to an earphone, and is further provided with a detection contact; wherein the power supply integrated control board is provided with a microcontroller, an overcurrent and short-circuit protection circuit, a polarity reversal controller and a detection circuit configured to detect whether the earphone is connected thereto; the microcontroller has a first end configured to detect a voltage on the detection contact, a second end configured to supply one of a pull-up voltage and a pull-down voltage to the detection circuit, a third end configured to detect a state parameter of indicating whether there is short-circuit behavior or indicating a magnitude of a current, and fourth and fifth ends configured to output polarity control signals respectively; the detection circuit is electrically connected to the first and second ends of the microcontroller and the detection contact; a first end of the polarity reversal controller is electrically connected to the third end of the microcontroller, and the overcurrent and short-circuit protection circuit is electrically connected between the power supply and the first end of the polarity reversal controller; second and third ends of the polarity reversal controller serve as two charging output ends respectively, and are electrically connected to the first power supply contact and the second power supply contact respectively; and fourth and fifth ends of the polarity reversal controller are electrically connected to the fourth and fifth ends of the microcontroller respectively.

In an embodiment of the disclosure, the second end and the third end of the polarity reversal controller are grounded through resistors.

It can be seen from the above that the embodiments of the disclosure can achieve the following beneficial effects, for example: the wearable earphone charger provided by the embodiment of the disclosure includes the wearable bracket and the two power supply seats disposed on the bracket, the bracket is provided with the power supply integrated control board and the power supply that are electrically connected with each other, each of the two power supply seats is electrically connected to the power supply integrated control board, and each of the two power supply seats is provided with the first and second power supply contacts that are configured to supply power to the earphone and is further provided with the detection contact, the power supply integrated control board is provided with the detection circuit that is configured to detect whether the earphone is connected thereto, and the detection circuit is electrically connected with the detection contact. The power supply integrated control board automatically can reverse the output positive and negative polarities based on a detected magnitude of current, and take polarities corresponding to that the magnitude of current meets a range and there is no short-circuit phenomenon as a charging polarity setting, which makes the device structure free from the constraints of positive and negative polarities and the structural design be simplified, and thus it is convenient to use. Moreover, the detection circuit can detect open-circuit and short-circuit characteristics of the detection contact and the power supply contacts, and then determine a device state by cooperating with positive and negative polarities of charging. Therefore, the embodiment of the disclosure can realize the automatic adjustment of positive and negative polarities of the wearable earphone charger, can automatically protect the earphone from being short-circuited and open-circuited, and thus is with high reliability and improved user experience.

### BRIEF DESCRIPTION OF THE DRAWINGS

In order to explain the technical schemes of embodiments of the disclosure more clearly, the following will briefly introduce the attached drawings used in the embodiments of the disclosure; apparently, the drawings introduced in the following description are only some of embodiments of the disclosure. For those skilled in the art, other drawings can be obtained from these drawings without paying creative labor.

FIG. 1A illustrates a schematic structural view of a wearable earphone charger with automatic adjustment of positive and negative polarities according to an embodiment of the disclosure.

FIG. 1B illustrates a schematic view of connection relationships among power supply seats, a power supply integrated control board and a power supply according to an embodiment of the disclosure.

FIG. 2 illustrates a schematic circuit diagram of a power supply integrated control board of a wearable earphone charger with automatic adjustment of positive and negative polarities according to an embodiment of the disclosure.

### DETAILED DESCRIPTION OF EMBODIMENTS

In order to make the purposes, technical schemes and advantages of embodiments of the disclosure clearer, the technical schemes in the embodiments of the disclosure will be clearly and completely described below in combination with the accompanying drawings. Apparently, the described embodiments are only some of embodiments of the disclosure rather than all of embodiments. Based on the embodiments described in the disclosure, all other embodiments obtained by those skilled in the art without creative labor belong to the scope of protection of the disclosure.

It should be noted that all directional indications (such as up, down, left, right, front, rear . . . ) in the embodiments of the disclosure are only used to explain the relative position relationship and motion between components in a specific attitude (as shown in the attached drawings). If the specific attitude changes, the directional indication will also change accordingly.

In the disclosure, unless otherwise expressly specified and limited, the terms “connected”, “disposed”, etc. should be understood in a broad sense. For example, “disposed” can be a fixed connection, a detachable connection, or integrated into one; it can be a mechanical connection or an electrical connection; it can be directly connected or indirectly connected through an intermediate medium; it can be an internal connection between two elements or an interaction relationship between two elements, unless otherwise expressly limited. For those skilled in the art, specific meanings of the above terms in the disclosure can be understood according to specific circumstances.

In addition, the descriptions of “first”, “second”, etc. in the disclosure are only for illustrative purposes, and cannot be understood as indicating or implying its relative importance or implicitly indicating the number of indicated technical features. Thus, the features defined with “first” and “second” may explicitly or implicitly include at least one of the features. In addition, the technical schemes among various embodiments can be combined with each other, but it must be based on the realization of those skilled in the art. When the combination of the technical schemes is contradictory or infeasible, it should be considered that the combination of the technical schemes does not exist and is not within the scope of protection of the disclosure.

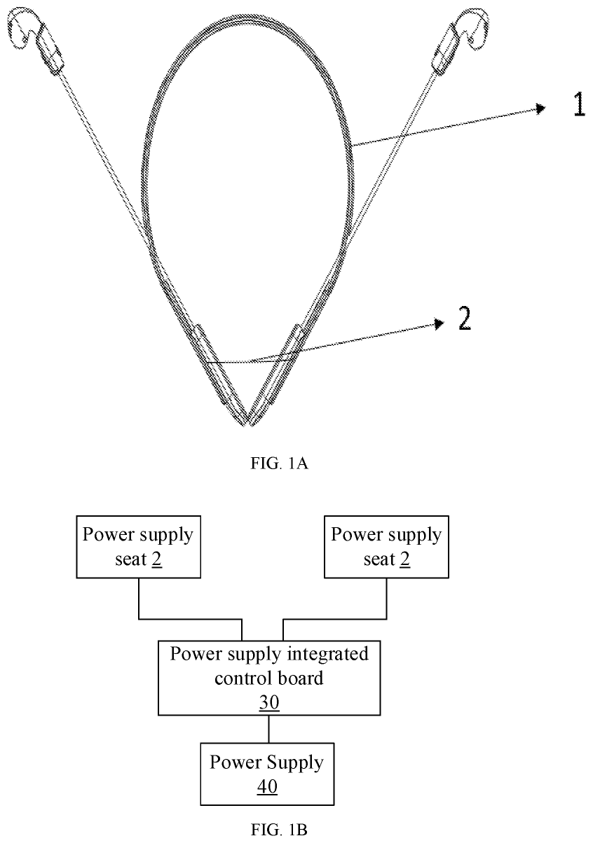

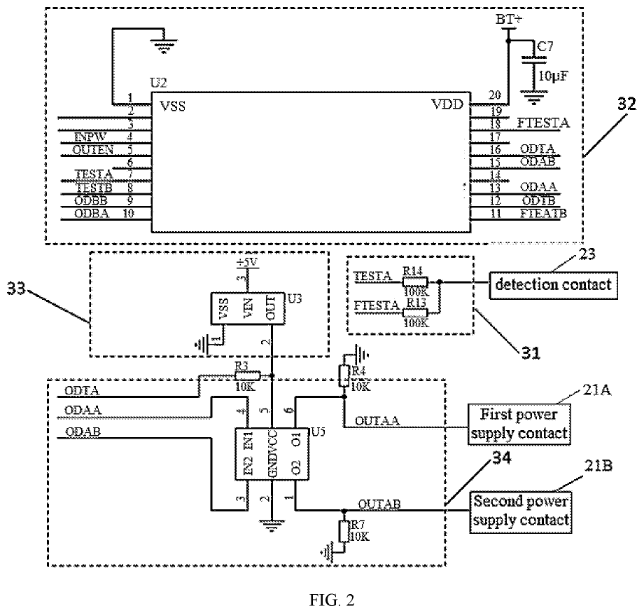

An embodiment of the disclosure provides a wearable earphone charger (also referred to as wearable charger for earphones) with automatic adjustment of positive and negative polarities, as illustrated in FIG. 1A, FIG. 1B, and FIG. 2, the wearable earphone charger includes a wearable bracket 1, and two power supply seats 2 for supplying power to earphones. A power supply integrated control board 30 and a power supply 40 are provided on the bracket 1, and the power supply integrated control board 30 and the power supply 40 are electrically connected to each other. Each of the two power supply seats 2 is disposed on the bracket 1, which is directly disposed such as fixed on the bracket 1 in a snap fit manner, or indirectly disposed such as fixed to the bracket 1 by a connector. Each of the two power supply seats 2 is electrically connected to the power supply integrated control board 30, and each of the two power supply seats 2 is provided with two power supply contacts (also referred to as a first power supply contact 21A and a second power supply contact 21B) that are configured to supply power to a charged device such as the earphone, and is further provided with a detection contact 23. The power supply integrated control board 30 is provided with a detection circuit 31 that is configured (i.e., structured and arranged) to detect whether the earphone is connected or not, and the detection circuit 31 is electrically connected to the detection contact 23. The power supply integrated control board 30 can automatically reverse output positive and negative polarities based on a detected magnitude of current, and take polarities corresponding to that the magnitude of current meets a preset range and there is no short-circuit phenomenon as a charging polarity setting, which makes a device structure free from the constraints of the positive and negative polarities and a structural design be simplified, and thus it is convenient to use. Moreover, the detection circuit 31 can detect open-circuit and short-circuit characteristics of the detection contact 23 and the power supply contacts 21A and 21B, and then determine the device state by cooperating with positive and negative polarities of charging. Therefore, the embodiment of the disclosure can realize the automatic adjustment of positive and negative polarities of the wearable earphone charger, and can automatically protect the earphone from being short-circuited and open-circuited, and thus is with high reliability and improved user experience.

The power supply integrated control board 30 may include: a main control circuit 32, an overcurrent and short-circuit protection circuit 33, and a polarity reversal control circuit 34. The main control circuit 32 includes, for example, a single-chip microcomputer controller U2 or other microcontrollers (such as digital signal processor, abbreviation as DSP). The overcurrent and short-circuit protection circuit 33 and the polarity reversal control circuit 34 are electrically connected to the single-chip microcomputer controller U2.

The detection circuit 31 may include a first resistor R14 and a second resistor R13. A first end TESTA of the single-chip microcomputer controller U2 is electrically connected to the detection contact 23 through the first resistor R14 of the detection circuit 31, and a second end FTESTA of the single-chip microcomputer controller U2 is electrically connected to the detection contact 23 through the second resistor R13 of the detection circuit 31. It can be understood that the first end TESTA of the single-chip microcomputer controller U2 is used/configured to detect a voltage on the detection circuit 31 (corresponding to a voltage on the detection contact 23). The second end FTESTA of the single-chip microcomputer controller U2 is used to supply a pull-up voltage or a pull-down voltage to the detection circuit 31 (that is, to supply a pull-up voltage or a pull-down voltage to the detection contact 23). When the detection circuit 31 is supplied with the pull-up voltage (corresponding to the detection contact 23 is supplied with a pull-up voltage), the single-chip microcomputer controller U2 enters a standby mode. In this embodiment, resistance values of the first resistor R14 and the second resistor R13 are, for example, 100 kiloohms (KΩ).

The polarity reversal control circuit 34 includes, for example, a polarity reversal controller U5, a third resistor R3, a fourth resistor R4, and a fifth resistor R7. A first end of the third resistor R3 is electrically connected to a third end ODTA of the single-chip microcomputer controller U2, a second end of the third resistor R3 is electrically connected to the overcurrent and short-circuit protection circuit 33 and a first end VCC of the polarity reversal controller U5. A second end O1 of the polarity reversal controller U5 is electrically connected to the first power supply contact 21A and a first end of the fourth resistor R4, and a second end of the fourth resistor R4 is grounded. A third end O2 of the polarity reversal controller U5 is electrically connected to a first end of the fifth resistor R7 and the second power supply contact 21B, and a second end of the fifth resistor R7 is grounded. A fourth end 1N1 and a fifth end 1N2 of the polarity reversal controller U5 are electrically connected to a fourth end ODAA and a fifth end ODAB of the single-chip microcomputer controller U2 respectively, and a sixth end GND of the polarity reversal controller U5 is grounded. It can be understood that the second end O1 of the polarity reversal controller U5 serves as a first charging output end OUTAA, and the third end O2 of the polarity reversal controller U5 serves as a second charging output end OUTAB. The fourth end ODAA and the fifth end ODAB of the single-chip microcomputer controller U2 are used to output a first polarity control signal and a second polarity control signal respectively. The fourth resistor R4 and the fifth resistor R7 can make the first charging output end OUTAA and the second charging output end OUTAB in a high resistance state. When the detection contact 23 is shorted with one of the power supply contact 21A and the power supply contact 21B (correspondingly, the detection circuit 31 is shorted with the first charging output end OUTAA or the second charging output end OUTAB), pulling down the pull-up voltage of the detection circuit 31, and a signal of the first end TESTA of the single-chip microcomputer controller U2 is at a low level, thus the single-chip microcomputer controller U2 wakes up from the standby mode, for example, the single-chip microcomputer controller U2 starts polarity reversal to find correct output positive and negative polarities to output power supply. In this embodiment, resistance values of the fourth resistor R4 and the fifth resistor R7 are, for example, 10 kiloohms, and a resistance value of the third resistor R3 is, for example, 10 kiloohms.

In this embodiment, when the detection circuit 31, the first charging output end OUTAA and the second charging output end OUTAB all are in an open-circuit state (correspondingly, the detection contact 23, the first power supply contact 21A and the second power supply contact 21B all are in an open-circuit state), the voltage on the detection circuit 31 is a pull-up voltage (also referred to as high-level voltage), the single-chip microcomputer controller U2 determines that there is no charged device is connected at this time, and the single-chip microcomputer controller U2 then enters the standby mode.

When the detection circuit 31 is shorted with both the first charging output end OUTAA and the second charging output end OUTAB (correspondingly, the detection contact 23 is shorted with both the first power supply contact 21A and the second power supply contact 21B), the pull-up voltage of the detection circuit 31 is pulled down or the pull-down voltage of the detection circuit 31 is pulled up by the first charging output end OUTAA or the second charging output OUTA, and it is determined that there is a charged device is connected at this time, and the output is started, and the detection circuit can further detect a polarity of an electrode of the earphone in contact with the first power supply contact 21A and the second power supply contact 21B is positive or negative before charging the earphone; however, the third end ODTA of the single-chip microcomputer controller U2 detects a short-circuit protection and sends a short-circuit signal, indicating that the output cannot be established, the output is closed and then it tries to output again after reversing the output polarities. In this way, after reaching a certain limit number of times, the single-chip microcomputer controller U2 enters the standby mode (cooperating with the short-circuit protection and the setting of pull-up voltage or pull-down voltage on the detection contact 23).

When the first charging output end OUTAA and the second charging output end OUTAB are shorted together, because the detection contact 23 is in an open-circuit state, it is determined that there is no charged device is connected at this time, the output voltage is 0, and the single-chip microcomputer controller U2 enters the standby mode.

When one of the first charging output end OUTAA and the second charging output end OUTAB is shorted with the detection circuit 31 (correspondingly, one of the first power supply contact 21A and the second power supply contact 21B is shorted with the detection contact 23), because the pull-up voltage on the detection circuit 31 is pulled down (correspondingly, the pull-up voltage on the detection contact 23 is pulled down), the single-chip microcomputer controller U2 starts a polarity reversal operation to find correct output positive and negative polarities to output power.

More specifically, in the standby mode, the first polarity control signal ODAA and the second polarity control signal ODAB both are at low levels, the first charging output end OUTAA and the second charging output end OUTAB are in high resistance states, the second end FTESTA of the single-chip microcomputer controller U2 outputs a high level to the detection contact, and the signal on the first end TESTA of the single-chip microcomputer controller U2 is a high level and sent to the single-chip microcomputer controller U2.

In a charging state, the first polarity control signal ODAA is at a high level, the second polarity control signal ODAB is at a low level, the voltage on the first charging output end OUTAA is the power supply voltage (e.g., +5v), and the voltage of the second charging output end OUTAB is 0. Alternatively, the first polarity control signal ODAA is at the low level, the second polarity control signal ODAB is at the high level, the voltage on the first charging output end OUTAA is 0 and the voltage on the second charging output end OUTAB is the power supply voltage.

In addition, the overcurrent and short-circuit protection circuit 33 includes an overcurrent and short-circuit protection controller U3. A first end OUT of the overcurrent and short-circuit protection controller U3 is electrically connected to a second end of the third resistor R3, a second end VIN of the overcurrent and short-circuit protection controller U3 is connected to the power supply, and a third end VSS of the overcurrent and short-circuit protection controller U3 is grounded. It can be understood that in this embodiment, the third end ODTA of the single-chip microcomputer controller U2 is used to detect a state parameter of indicating whether there is an external short-circuit behavior or indicating a magnitude of current. Specifically, after the work is started, the power supply 40 supplies power to the overcurrent and short-circuit protection controller U3, and a voltage drop of the overcurrent and short-circuit protection controller U3 will increase when the output current is too large, the single-chip microcomputer controller U2 can collect the voltage drop and output the state parameter of indicating whether there is an external short-circuit behavior or indicating the magnitude of current for judgment. In addition, the overcurrent and short-circuit protection controller U3 itself has a strong anti-overload ability, and the response of the single-chip microcomputer controller U2 is fast enough, thereby realizing the external short-circuit protection and the determination of polarity direction.

The main control circuit 32 further includes, for example, a first capacitor C7. A first end of the first capacitor C7 is electrically connected to a sixth end VDD of the single-chip microcomputer controller U2 and a high potential terminal BT+, and a second end of the first capacitor C7 is grounded.

The supply voltage of the power supply 40 is, for example, +5V. It can be understood that when charging ends of the BLUETOOTH earphone (provided with positive and negative electrically conductive sheets) are shorted with the detection contact 23 and one of the two power supply contacts 21A and 21B respectively, the main control circuit 32 starts an output direction detection, determines the direction and then supplies charging power to the BLUETOOTH earphone. The BLUETOOTH earphone charges a lithium battery inside the earphone through its own internal charging management chip.

To sum up, the wearable earphone charger with automatic adjustment of positive and negative polarities provided by the illustrated embodiments of the disclosure includes the wearable bracket 1 and the two power supply seats 2 configured to supply power to earphones, the bracket 1 is provided with the power supply integrated control board 30 and a power supply 40 connected to the power supply integrated control board 30, the power supply seats 2 are arranged on the bracket 1, the power supply seats 2 are electrically connected to the power supply integrated control board 30 individually, each of the power supply seats 2 is provided with the two power supply contacts 21A and 21B to supply power to the earphone and is further provided with the detection contact 23, the power supply integrated control board 30 is provided with the detection circuit 31 to detect whether the earphone is connected or not, and the detection circuit 31 is electrically connected to the detection contact 23. The power supply integrated control board 30 can automatically reverse output positive and negative polarities based on detection of current magnitude and take polarities corresponding to that a detected current magnitude meets a preset range and there is no short-circuit phenomenon as a charging polarity setting, which makes the device structure free from the constraints of the positive and negative polarities and the structural design be simplified, and thus it is convenient to use. The detection circuit 31 can detect the open-circuit and short-circuit characteristics of the detection contact 23 and the two power supply contacts 21A and 21B, and then determine the device state by cooperating with positive and negative polarities of charging. Therefore, the illustrated embodiments of the disclosure can realize the automatic adjustment of positive and negative polarities of the wearable earphone charger, can automatically protect the earphone from being short-circuited and open-circuited, and thus is with high reliability and improved user experience.

The above are only schematic embodiments of the disclosure, and does not limit the scope of protection of the disclosure. On the premise of not departing from the spirit and scope of the invention of the disclosure, the disclosure will also have various changes and improvements. Under the invention concept of the disclosure, the equivalent structural transformation made by using the contents of the description and drawings of the disclosure, or directly/indirectly applied in other related technical fields, are included in the scope of patent protection of the disclosure.

What is claimed is:

1. A wearable earphone charger, comprising: a wearable bracket, and two power supply seats disposed on the bracket;
wherein the bracket is disposed with a power supply integrated control board and a power supply, and the power supply integrated control board and the power supply are electrically connected with each other;
wherein each of the two power supply seats is electrically connected to the power supply integrated control board, and each of the two power supply seats is disposed with a first power supply contact and a second power supply contact that are configured to supply power to an earphone and is further disposed with a detection contact; and
wherein the power supply integrated control board is disposed with a detection circuit configured to detect whether the earphone is connected thereto, and the detection circuit is electrically connected to the detection contact.

2. The wearable earphone charger according to claim 1, wherein the power supply integrated control board is further disposed with a main control circuit, an overcurrent and short-circuit protection circuit, and a polarity reversal control circuit; the main control circuit comprises a single-chip microcomputer controller, and the overcurrent and short-circuit protection circuit and the polarity reversal control circuit are electrically connected to the single-chip microcomputer controller.

3. The wearable earphone charger according to claim 2, wherein the detection circuit comprises: a first resistor and a second resistor; a first end of the single-chip microcomputer controller is electrically connected to the detection contact through the first resistor, and configured to detect a voltage on the detection contact; and a second end of the single-chip microcomputer controller is electrically connected to the detection contact through the second resistor, and configured to supply one of a pull-up voltage and a pull-down voltage to the detection circuit.

4. The wearable earphone charger according to claim 3, wherein the polarity reversal control circuit comprises a polarity reversal controller, a third resistor, a fourth resistor, and a fifth resistor;
wherein a first end of the third resistor is electrically connected to a third end of the single-chip microcomputer controller, a second end of the third resistor is electrically connected to the overcurrent and short-circuit protection circuit and a first end of the polarity reversal controller, and the third end of the single-chip microcomputer controller is configured to detect a state parameter of indicating whether there is a short-circuit behavior or indicating a magnitude of a current;
wherein a second end of the polarity reversal controller is electrically connected to the first power supply contact and a first end of the fourth resistor, a second end of the fourth resistor is grounded, a third end of the polarity reversal controller is electrically connected to a first end of the fifth resistor and the second power supply contact, and a second end of the fifth resistor is grounded; and
wherein a fourth end and a fifth end of the polarity reversal controller are electrically connected to a fourth end and a fifth end of the single-chip microcomputer controller respectively, a sixth end of the polarity reversal controller is grounded, and the fourth end and the fifth end of the single-chip microcomputer controller are configured to output polarity control signals respectively.

5. The wearable earphone charger according to claim 4, wherein the overcurrent and short-circuit protection circuit comprises an overcurrent and short-circuit protection controller, a first end of the overcurrent and short-circuit protection controller is electrically connected to the second end of the third resistor, and a second end of the overcurrent and short-circuit protection controller is electrically connected to the power supply, and a third end of the overcurrent and short-circuit protection controller is grounded.

6. The wearable earphone charger according to claim 5, wherein the main control circuit further comprises a first capacitor, a first end of the first capacitor is electrically connected to a sixth end of the single-chip microcomputer controller and a high potential terminal, and a second end of the first capacitor is grounded.

7. The wearable earphone charger according to claim 6, wherein a supply voltage of the power supply is +5V.

8. The wearable earphone charger according to claim 2, wherein the detection circuit is further configured to detect a polarity of an electrode of the earphone in contact with the first power supply contact and the second power supply contact is positive or negative before charging the earphone.

9. A wearable earphone charger, comprising: a wearable bracket, and two power supply seats disposed on the bracket; wherein the bracket is provided with a power supply integrated control board and a power supply electrically connected to the power supply integrated control board, and each of the two power supply seats is provided with a first power supply contact and a second power supply contact that are configured to supply power to an earphone, and is further provided with a detection contact; and
wherein the power supply integrated control board is provided with a main control circuit, a polarity reversal control circuit, and a detection circuit configured to detect whether the earphone is connected; the detection circuit is electrically connected to the main control circuit and the detection contact; and the polarity reversal control circuit is electrically connected to the main control circuit, the power supply, the first power supply contact and the second power supply contact.

10. The wearable earphone charger according to claim 9, wherein the main control circuit comprises a microcontroller, and the microcontroller has first to fifth ends; the detection circuit comprises a first resistor and a second resistor; the first end of the microcontroller is electrically connected to the detection contact through the first resistor and configured to detect a voltage on the detection contact; and the second end of the microcontroller is electrically connected to the detection contact through the second resistor and configured to supply one of a pull-up voltage and a pull-down voltage to the detection circuit; and
wherein the polarity reversal control circuit comprises: a polarity reversal controller, a third resistor, a fourth resistor, and a fifth resistor; a first end of the third resistor is electrically connected to the third end of the microcontroller, a second end of the third resistor is electrically connected to a first end of the polarity reversal controller, the first end of the polarity reversal controller is electrically connected to the power supply through an overcurrent and short-circuit protection circuit, the third end of the microcontroller is configured to detect a state parameter of indicating whether there is a short-circuit behavior or indicating a magnitude of a current, a second end of the polarity reversal controller is electrically connected to the first power supply contact and a first end of the fourth resistor, a second end of the fourth resistor is grounded, a third end of the polarity reversal controller is electrically connected to a first end of the fifth resistor and the second power supply contact, and a second end of the fifth resistor is grounded; a fourth end and a fifth end of the polarity reversal controller are electrically connected to the fourth end and the fifth end of the microcontroller respectively, a sixth end of the polarity reversal controller is grounded, and the fourth end and the fifth end of the microcontroller are configured to output polarity control signals respectively.

11. A wearable earphone charger, comprising: a wearable bracket, and two power supply seats disposed on the bracket; wherein the bracket is provided with a power supply integrated control board and a power supply, and the power supply integrated control board and the power supply are electrically connected with each other; and each of the two power supply seats is provided with a first power supply contact and a second power supply contact that are configured to supply power to an earphone, and is further provided with a detection contact; and
wherein the power supply integrated control board is provided with a microcontroller, an overcurrent and short-circuit protection circuit, a polarity reversal controller, and a detection circuit configured to detect whether the earphone is connected or not; the microcontroller has a first end configured to detect a voltage on the detection contact, a second end configured to supply one of a pull-up voltage and a pull-down voltage to the detection circuit, a third end configured to detect a state parameter of indicating whether there is a short-circuit behavior or indicating a magnitude of a current, and fourth and fifth ends configured to output polarity control signals;
wherein the detection circuit is electrically connected to the first and second ends of the microcontroller and the detection contact;
wherein a first end of the polarity reversal controller is electrically connected to the third end of the microcontroller, and the overcurrent and short-circuit protection circuit is electrically connected between the power supply and the first end of the polarity reversal controller;
wherein second and third ends of the polarity reversal controller serve as two charging output ends respectively, and are electrically connected to the first power supply contact and the second power supply contact respectively; and
wherein fourth and fifth ends of the polarity reversal controller are electrically connected to the fourth and fifth ends of the microcontroller respectively.

12. The wearable earphone charger according to claim 11, wherein the second end and the third end of the polarity reversal controller are grounded through resistors.
